(19) United States
(12) Patent Application Publication
(10) Pub. No.: US 2019/0089806 A1
(43) Pub. Date: Mar. 21, 2019

(54) PROVISIONING A DEVICE FOR USE IN A PERSONAL AREA NETWORK

(71) Applicant: QUALCOMM Incorporated, San Diego, CA (US)

(72) Inventor: Anand Vasant Deshpande, San Jose, CA (US)

(21) Appl. No.: 15/706,479

(22) Filed: Sep. 15, 2017

(51) Int. Cl. H04L 29/08; H04W 84/18; H04W 76/02; H04W 48/12; H04W 72/04

(52) U.S. Cl. CPC H04L 67/303; H04W 84/18; H04W 8/005; H04W 48/12; H04W 72/04; H04W 76/025

(57) ABSTRACT

This disclosure provides systems, methods, and apparatus, including computer programs encoded on computer storage media, for commissioning a first device in a personal area network. The commissioning can be done via an out-of-band provisioning communication link between a commissioning device and the first device. Using the same provisioning communication link, a first device can be configured for two different networks (such as a wireless local area network and the personal area network). Thus, onboarding the first device for multiple networks can be done during a same out-of-band onboarding connection. The role that a first device will take in the personal area network can be based on the first device's power supply type (such as battery-powered or powerline-powered).

### TECHNICAL FIELD

This disclosure generally relates to the field of communication systems, and, more particularly to device provisioning.

### DESCRIPTION OF THE RELATED TECHNOLOGY

A network includes devices that communicate with each other via a communication medium. A device is configured with parameters to access the communication medium before the device can communicate with other devices of the network. The process of configuring a device may be referred to as onboarding or device provisioning. Previous methods for provisioning a device for a network may depend on manual entry performed by a user and may be complicated or difficult for the user. For example, in traditional communication systems, a user was prompted to enter security credentials.

There are different types of wireless networks that may operate in an environment. For example, a personal area network (PAN) and a wireless local area network (WLAN) may both operate in the environment. Different network protocols and network configurations may be needed for each type of network that a device may join. Provisioning a device for such networks may be simplified to improve a customer experience.

### SUMMARY

The systems, methods, and devices of this disclosure each have several innovative aspects, no single one of which is solely responsible for the desirable attributes disclosed herein.

One innovative aspect of the subject matter described in this disclosure can be implemented by a first device for use in at least one communication network. The first device may establish a provisioning communication link between the first device and a commissioning device via an out-of-band interface that is different from a first network interface and a second network interface of the first device. The first device may receive, via the provisioning communication link, a first network configuration for a first network that is accessible by the first network interface. The first device may receive, via the provisioning communication link, a second network configuration for a second network that is accessible by the second network interface.

In some implementations, the first device may establish communication with the first network via the first network interface using the first network configuration. The first device may establish communication with the second network via the second network interface using the second network configuration.

In some implementations, the first network is a wireless local area network and the second network is a personal area network.

In some implementations, the out-of-band interface is a short-range radio frequency communication interface, and wherein the provisioning communication link is a secure peer-to-peer session using short-range radio frequency communication.

In some implementations, receiving the second network configuration includes at least one of receiving a commissioning credential or a joining passphrase for a personal area network.

In some implementations, receiving the second network configuration includes receiving a role type for the first device to use in a personal area network. The role type may be based, at least in part, on a power supply type used by the first device.

In some implementations, before receiving the second network configuration, the first device may provide hardware data to the commissioning device. The hardware data may describe the power supply type used by the first device.

In some implementations, the role type for the first device indicates the first device is a joiner router in the personal area network when the power supply type of the first device is powerline-powered. In some implementations, the role type for the first device indicates the first device is an endpoint joiner when the power supply type of the first device is battery-powered.

In some implementations, the first device is powerline-powered and the first device has a battery backup. In some implementations, the first device may determine that a power supply of the first device has switched from a powerline power source to the battery backup. The first device may change a role type for the first device from the joiner router to the endpoint joiner in response to determining that the power supply of the first device has switched from the powerline power source to the battery backup.

In some implementations, in response to changing the role type to the endpoint joiner, the first device may disassociate other devices connected to the first device. The first device may re-establish communication with the second network via the second network interface using the role type of the endpoint joiner.

In some implementations, the first device may determine pairing information for the out-of-band interface. The pairing information may be used between the first device and a second device that is configured with the pairing information by the commissioning device.

In some implementations, the first device may receive a pairing request from the second device. The first device may determine that the pairing request matches the pairing information. The first device may establish a peer-to-peer session with the second device in response to determining that the pairing request matches the pairing information.

Another innovative aspect of the subject matter described in this disclosure can be implemented in a first device for use in at least one communication network. The first device may include a processor, a first network interface, a second network interface, an out-of-band interface that is different from the first network interface, and memory coupled to the processor and having instructions stored therein. The instructions, when executed by the processor, may cause the first device to establish a provisioning communication link between the first device and a commissioning device via the out-of-band interface, receive, via the provisioning communication link, a first network configuration for a first network that is accessible by the first network interface, and receive, via the provisioning communication link, a second network configuration for a second network that is accessible by the second network interface.

In some implementations, the instructions, when executed by the processor, cause the first device to establish communication with the first network via the first network interface using the first network configuration and establish communication with the second network via the second network interface using the second network configuration.

In some implementations, receiving the second network configuration includes at least one of receiving a commissioning credential or a joining passphrase for a personal area network.

In some implementations, the second network configuration includes a role type for the first device to use in a personal area network, and the role type is based, at least in part, on a power supply type used by the first device.

In some implementations, the instructions, when executed by the processor, cause the first device to provide hardware data to the commissioning device. The hardware data may describe the power supply type used by the first device.

In some implementations, the instructions, when executed by the processor, cause the first device to determine pairing information for the out-of-band interface. The pairing information may be used between the first device and a second device that is configured with the pairing information by the commissioning device.

In some implementations, the instructions, when executed by the processor, cause the first device to receive a pairing request from the second device, determine that the pairing request matches the pairing information, and establish a peer-to-peer session with the second device in response to a determination that the pairing request matches the pairing information.

Another innovative aspect of the subject matter described in this disclosure can be implemented in a machine-readable medium having instructions stored therein which, when executed by a processor of a first device, cause the first device to establish a provisioning communication link between the first device and a commissioning device via an out-of-band interface that is different from a first network interface and a second network interface of the first device, receive, via the provisioning communication link, a first network configuration for a first network that is accessible by the first network interface, and receive, via the provisioning communication link, a second network configuration for a second network that is accessible by the second network interface.

Another innovative aspect of the subject matter described in this disclosure can be implemented in a system. The system may include means for establishing a provisioning communication link between the first device and a commissioning device via an out-of-band interface that is different from a first network interface and a second network interface of the first device. The system may include means for receiving, via the provisioning communication link, a first network configuration for a first network that is accessible by the first network interface. The system may include means for receiving, via the provisioning communication link, a second network configuration for a second network that is accessible by the second network interface.

Another innovative aspect of the subject matter described in this disclosure can be implemented by a commissioning device. The commissioning device may establish a provisioning communication link between the commissioning device and a first device via an out-of-band interface of the first device that is different from a first network interface and a second network interface of the first device. The commissioning device may provide, via the provisioning communication link, a first network configuration for the first network interface, the first network configuration associated with a first network. The commissioning device may provide, via the provisioning communication link, a second network configuration for the second network interface, the second network configuration associated with a second network.

In some implementations, providing the second network configuration includes at least one of providing a commissioning credential or a joining passphrase for a personal area network.

In some implementations, the commissioning device may determine a role type for the first device to use in a personal area network based, at least in part, on a power supply type used by the first device. The second network configuration may be based, at least in part, on the role type.

In some implementations, determining the role type includes receiving hardware data from the first device. The hardware data may describe the power supply type used by the first device.

In some implementations, the role type for the first device indicates the first device is a joiner router in the personal area network when the power supply type of the first device is determined to be powerline-powered. In some implementations, the role type for the first device indicates the first device is an endpoint joiner when the power supply type of the first device is determined to be battery-powered.

In some implementations, providing the second network configuration includes providing a commissioning credential when the role type for the first device indicates the first device is a joiner router, and providing a joining passphrase when the role type for the first device indicates the first device is the endpoint joiner.

In some implementations, the commissioning device may determine pairing information for the out-of-band interface. The commissioning device may provide the pairing information to a second device, such that the second device can establish a peer-to-peer session between the second device and the first device.

In some implementations, the commissioning device may provide, via the provisioning communication link, a list of addresses of one or more existing devices in a personal area network that can accept a connection request from the first device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example system diagram to introduce concepts of provisioning a first device for use in a personal area network (PAN).

FIG. 2 shows an example system diagram in which a first device is provisioned by a commissioning device.

FIG. 3A shows a block diagram of an example first device.

FIG. 3B shows a block diagram of an example commissioning device.

FIG. 4 shows an example flowchart for determining a role type for the first device in a PAN.

FIG. 5 shows an example message flow diagram of provisioning a first device for use in a wireless local area network (WLAN) and a PAN.

FIG. 6 shows an example message flow diagram of provisioning a second device for use in the PAN.

FIG. 7 shows an example flowchart for a first device being provisioning by a commissioning device.

FIG. 8 shows an example flowchart for a commissioning device provisioning a first device.

FIG. 9 shows an example flowchart for a commissioning device provisioning a first device based on a role type.

FIG. 10 shows an example flowchart for in which a first device may change a role type based on power source.

FIG. 11 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, 5G, or 6G, or further implementations thereof, technology. For brevity, the examples in this disclosure may be based on a wireless personal area network technology as specified in the Thread specification by the Thread Group, Inc. However, this disclosure is not limited to a specific type of personal area network technology. For example, the techniques could be used in other network technologies, such as ZigBee, IPv6 over low-power wireless personal area networking (6LoWPAN), or other networks built over IEEE 15.4 physical layer.

This description is related to provisioning a device for a personal area network (PAN). A PAN is used for communication among personal devices. A wireless PAN (WPAN) may use low-powered communication over short distances. Examples of PANs include Thread, ZigBee, wireless universal serial bus (Wireless USB). In this disclosure, a PAN is different from a wireless local area network (WLAN). Examples of a WLAN may include an IEEE 802.11 wireless network. However, as described below, some devices may be provisioning for both a PAN and a WLAN, such as a device that has multiple network interfaces that can operate using the different network protocols. A network protocol is associated with each network and manages which devices can join the network. The network protocol may utilize network credentials for devices that join the network. However, provisioning a device with network credentials may be difficult or cumbersome for an average consumer. Furthermore, as new types of devices are developed for PANs, the devices may have different capabilities based on hardware design. For example, devices may be battery-powered or powerline-powered. In some implementations, a device may be powerline-powered with a battery backup. Depending on the hardware design (such as the power supply type), the device may be capable of operating using different roles in a PAN. Examples of roles include a border router (capable of bridging the PAN to another network, such as a WLAN), a joiner router (capable of bridging an endpoint joiner to the PAN), or an endpoint joiner.

In one aspect of this disclosure, a device can be provisioned for the PAN using a provisioning communication link via a short-range radio communication, such as Bluetooth. For example, Bluetooth Low Energy (BLE), or any other network technology, could be used to provision a device with one or more network credentials for a PAN or a WLAN. In some implementations, the same provisioning communication link can be used to provision a device for two different network protocols (such as a PAN and a WLAN) in a combined onboarding process. Provisioning the device for multiple networks during a same out-of-band onboarding connection can simplify the process for adding a device to multiple networks in the environment. In another aspect of this disclosure, a device role for a device in a PAN can be based on the device's hardware design (such as power supply type). For example, the device can be provisioned as a border router, joiner router, or joiner based on whether it is battery-powered or powerline-powered. In some implementations, the device can change its device role based the current power source that is in use by the device.

Particular implementations of the subject matter described in this disclosure can be implemented to realize one or more of the following potential advantages. Provisioning of a new PAN device can be simplified for an end user. Furthermore, the provisioning techniques in this disclosure may provide enhanced security and lower costs for new PAN devices. For example, the commissioning credential and joining passphrase can be made longer or more secure since they can be provided electronically by a commissioning device, potentially avoiding manual entered credentials by a human user. Thus, provisioning errors and difficulty can be reduced.

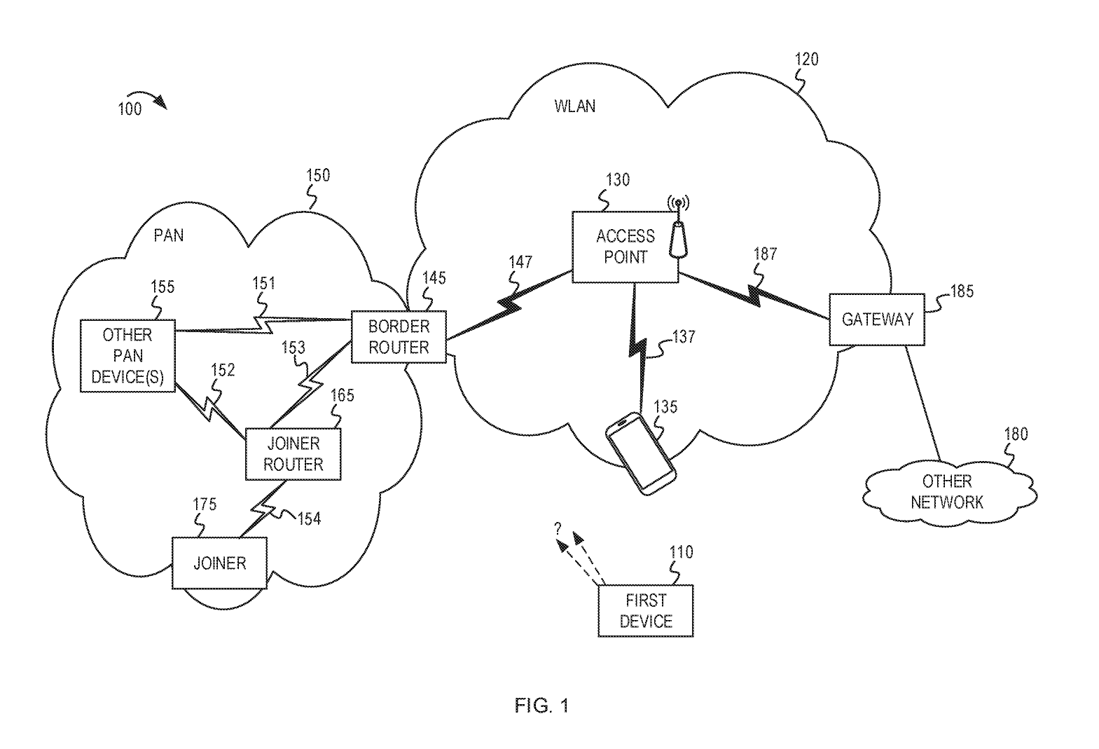

FIG. 1 shows an example system diagram to introduce concepts of provisioning a first device for use in a PAN. The system diagram 100 shows a PAN 150 and a WLAN 120 which may operate in an environment. The WLAN 120 includes an access point 130 that provides a wireless coverage area and network access for one or more wireless stations (referred to as “STAs”). In the example of FIG. 1, the WLAN 120 includes a mobile device 135 that is acting as a STA (via a wireless link 137) in the WLAN 120. The WLAN 120 also may have a gateway 185 configured to provide access to another network 180. In the example of FIG. 1, the gateway 185 is communicatively coupled via a wireless link 187 to the access point 130. In other examples, the gateway 185 may be communicatively coupled via a wireline link or may be co-located with the access point 130.

The access point 130 also has a wireless link 147 to a border router 145 of the PAN 150. The border router 145 is capable of forwarding traffic between the PAN 150 and the WLAN 120. It is noted that the role “border router” may be defined for the role type of the border router 145 in the PAN 150 and may not have significance for the role type (STA) of the border router 145 in the WLAN 120.

The PAN 150 includes the border router 145, a joiner router 165, a joiner 175, and one or more other PAN device(s) 155. In the example of FIG. 1, the PAN 150 uses a low power wireless mesh technology to communicate via wireless links 151, 152, 153, 154. As a non-limiting example, the PAN 150 may utilize a Thread network protocol. Thread defines the following roles for devices in the network: joiner (which also may be referred to as an endpoint joiner in this document), joiner router, and border router. A joiner is an endpoint device that can access the network through a joiner router or a border router. A joiner router is a device that can route traffic to another router (either border router or joiner router) or an endpoint (joiner). A border router is a device that can route between the Thread network and another type of network (such as a Powerline communications, PLC, or Wi-Fi network). Thread is a network layer protocol. The physical layer (PHY) and media access control (MAC) layer for Thread (or ZigBee) is based on the IEEE 802.15.4 (herein referred to as “15.4”) technical standard. IEEE 802.15.4 provides many benefits such as high power-saving, IPv6 support, and low overhead. Meanwhile, the thread network layer protocol provides access control and security credentials.

In FIG. 1, a first device 110 is attempting to join the PAN 150. For example, the first device 110 may be a new PAN device which has recently been obtained by an end user. However, before the first device 110 can be added to the PAN 150, it must be provisioned with network credentials associated with the PAN 150. The first device 110 can be used to describe challenges than an end user may face when adding a first device to the environment. For example, an end user may not be aware of the device hardware capabilities of the first device 110, such as whether it should be added to the WLAN 120, the PAN 150, or both the PAN 150 and the WLAN 120. Furthermore, the end user may be unaware of which role (border router, joiner router, or joiner) that the first device 110 should take in the PAN 150.

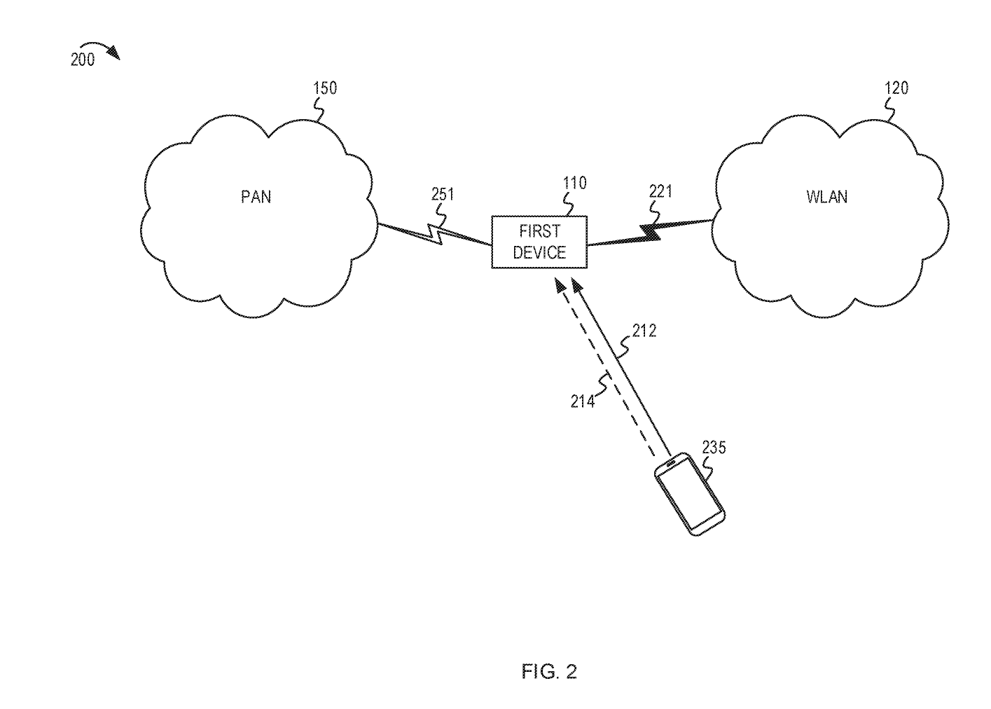

FIG. 2 shows an example system diagram in which a first device is provisioned by a commissioning device. The system diagram 200 shows a commissioning device 235 which can provision the first device 110 for either or both of the PAN 150 and the WLAN 120. The commissioning device 235 may be similar to the mobile device 135 of FIG. 1. For example, the commissioning device 235 may be a device that is already wirelessly associated with the WLAN 120. Alternatively, the commissioning device 235 may be a device within the PAN 150 or may be provisioned for both the WLAN 120 and the PAN 150. In yet another alternative, the commissioning device 235 may be separate from both the WLAN 120 and the PAN 150 but may have network credentials for one or both of the networks. For example, the commissioning device 235 may be a point-of-sale device, a provisioning server, or the like, in another network (not shown).

The commissioning device 235 can establish a provisioning communication link (such as a secure peer-to-peer session) with the first device 110 to provide the network credential(s). For example, the provisioning communication link could include a short-range radio frequency communication (such as Bluetooth) session. In some implementations, the provisioning communication link could be established using Bluetooth low energy (BLE) communication. BLE is a communication protocol and interface that is commonly-available on smartphones today and can provide a provisioning communication link over short-range. The provisioning communication link may be secured by a “public-private” key pair (such as, the keys in a Bluetooth peer-to-peer session). There are many ways in which the provisioning communication link can be established. For example, the commissioning device 235 may scan a barcode, a coded image, or a near field communication (NFC) tag to obtain a key for the provisioning communication link. Alternatively, the keys for the provisioning communication link can be dynamically created by the first device 110 and the commissioning device 235 in response to a connection request. Because the provisioning communication link (for example, via a Bluetooth session) may be established by devices in near proximity, the authenticity of the connection request may be assumed or secured by basic security in some implementations.

The provisioning communication link can be used to provision the first device 110 for more than one network during the same provisioning communication link. For example, the provisioning communication link can be used to share first network credentials 212 for the WLAN 120, such as WLAN credentials (service set identifier (SSID), network password, etc.). Then, the same provisioning communication link can be used to share a network credential 214 for the first device 110 to join the PAN 150. The network credential 214 may include a joining passphrase or a commissioning credential (depending on the role type for the first device 110 in the PAN 150). A joining passphrase provides authentication between the first device 110 that is joining the PAN 150 and an existing device (not shown) of the PAN 150. For example, the joining passphrase can be used by the first device 110 to communicate with a joiner router or border router of the PAN 150. A commissioning credential can be used by the first device 110 to become a commissioning device for a subsequent device (not shown) that may be added to the PAN 150 at a later time. For example, the commissioning credential may have been previously used by the commissioning device 235 to establish itself as a commissioner of the PAN 150. In some implementations, the first device 110 can be provisioned for the PAN 150 automatically by passing the network credential 214 over the provisioning communication link with little or no user interaction.

In some implementations, the mobile device can send further provisioning data to the first device. For example, in addition to the commissioning credential or joining passphrase, the mobile device may send pairing information to assist the first device to join the PAN 150. In some implementations, the pairing information may include a list of addresses (such as MAC addresses, device ID, or the like) of existing border routers or joiner routers in the PAN 150. For example, the list of addresses may include all existing border or joiner routers. Alternatively, the list of addresses may include a subset of the existing border or joiner routers. For example, the subset may include border routers or joiner routers that are within a proximity of the first device or that have favorable conditions (such as higher capacity or lower latency) to accept a join request from the first device. The first device may use this information to connect to the best available border router or joiner router.

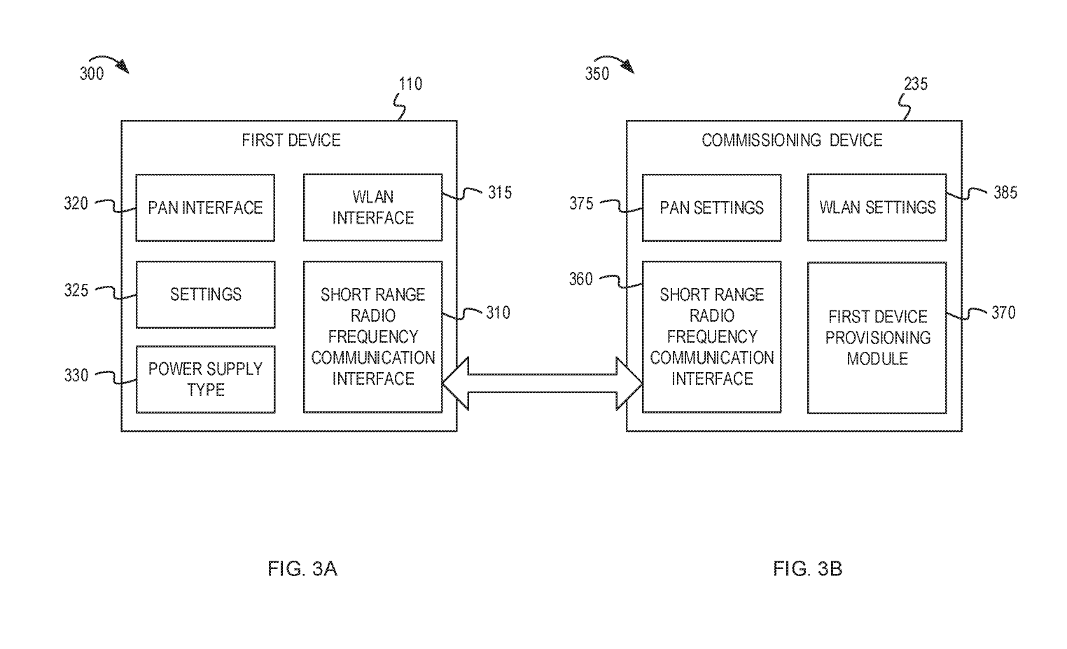

FIG. 3A shows a block diagram of an example first device. The block diagram 300 shows the first device 110 may include a short-range radio frequency communication interface 310 (such as Bluetooth or NFC). The short-range radio frequency communication interface 310 can be used to communicate with a commissioning device and receive the network credentials for the other network interfaces (such as a WLAN interface 315 and PAN interface 320). The first device 110 also has a memory storing settings 325 and a power supply type 330. The power supply type 330 may describe whether the first device 110 is battery-powered or powerline-powered (or powerline-powered with battery backup). In some instances, the power supply type 330 may be set by a manufacturer of the first device 110. For example, the power supply type 330 may be set in a register or other memory that can be accessed and provided to a commissioning device.

As shown in FIG. 3A, the first device 110 may support both a PAN and a WLAN. Thus, the first device 110 may be provisioned to act as a border router if it can bridge the WLAN and the PAN. The commissioning device may provision the first device 110 with network credentials for both the WLAN and the PAN using the same provisioning communication link via the short-range radio frequency communication interface 310. For example, the WLAN interface 315 can be provisioned for the WLAN and the PAN interface 320 can be provisioned for the PAN, without having to create separate provisioning communication links with the first device 110.

Although the first device 110 is depicted as having both a WLAN interface 315 and a PAN interface 320, some devices may have the PAN interface 320 but not the WLAN interface 315. Therefore, in another example, the first device 110 may be provisioned to act as a joiner router or an endpoint joiner. The joining passphrase to be used by the PAN interface 320 may be provisioned using a provisioning communication link via the short-range radio frequency communication interface 310. Furthermore, the commissioning device may send a role type setting for the first device 110 to store in the memory storing settings 325. The role type (joiner router or endpoint joiner) may be determined and set by the commissioning device, as described further below.

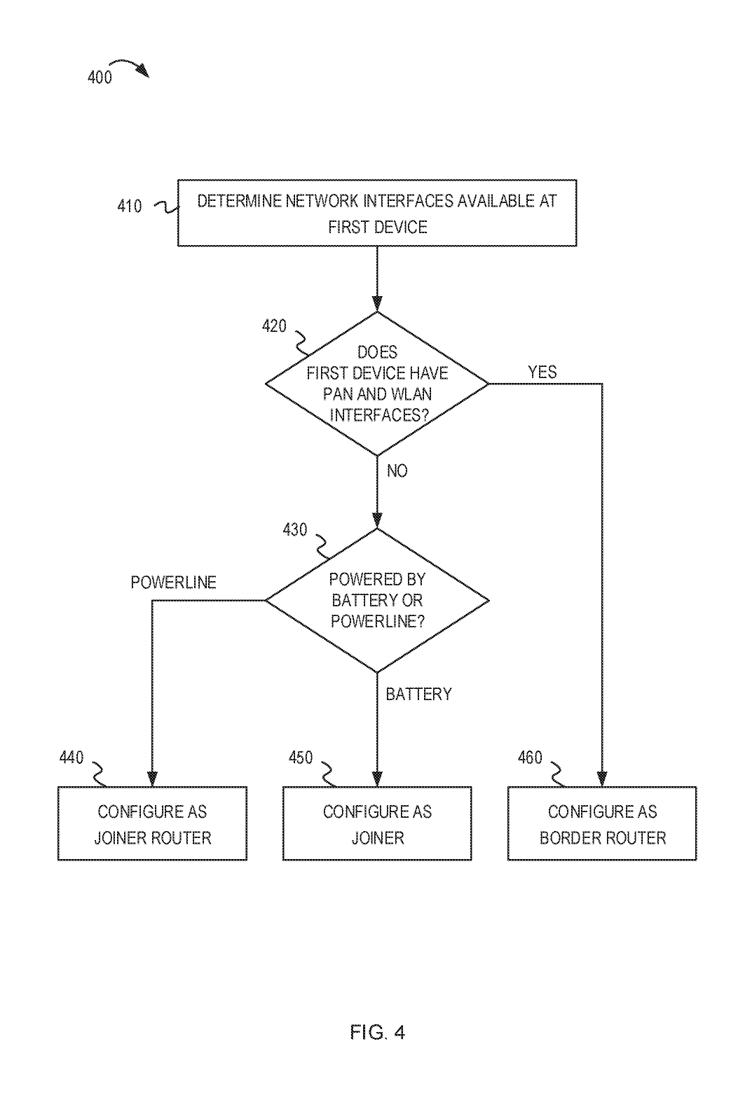

FIG. 3B shows a block diagram of an example commissioning device. The block diagram 350 shows the commissioning device 235. The commissioning device 235 includes a short-range radio frequency communication interface 360 (such as Bluetooth or NFC) to communicate with the first device. The commissioning device 235 may include PAN settings 375 and WLAN settings 385 that will be sent to the first device to provision the first device for the PAN and WLAN, respectively. The commissioning device 235 also may include a first device provisioning module 370. For example, the first device provisioning module 370 may be configured to determine a role type for the first device, send network credentials or the like. For example, the first device provisioning module 370 may implement one or more of the techniques described below in FIGS. 4, 8, and 9.

FIG. 4 shows an example flowchart for determining a role type for the first device in a PAN. The example flowchart 400 may be used by a commissioning device to determine whether to provisioning the first device with a role type of a joiner, a joiner router, or a border router. The role type may be based on the available network interfaces and the power source of the first device. The flowchart 400 begins at block 410.

At block 410, the commissioning device may determine the network interfaces available at the first device. At decision 420, if the first device has both PAN and WLAN interfaces, the flow continues to block 460. At block 460, the commissioning device may provision the first device as a border router. At decision 420, if the first device does not have both PAN and WLAN interfaces, the flow continues to decision 430. For example, if the first device has a PAN interface, but not a WLAN interface, the flowchart will continue to decision 430.

At decision 430, the commissioning device may determine if the first device is battery-powered or powerline-powered. For example, the commissioning device may access a memory/setting at the first device or may be provided with hardware data that describes a power supply type of the first device. At decision 430, if the device is powerline-powered, the flow continues to block 440. At block 440, the commissioning device may determine that the role type of the first device is a joiner router and may provision the first device as a joiner router.

At decision 430, if the device is battery-powered, the flow continues to block 450. At block 450, the commissioning device may determine that the role type of the first device is an endpoint joiner and may provision the first device as an endpoint joiner.

In some implementations, the order of decisions 420 and 430 may be reversed. For example, if the first device is battery-powered, the commissioning device may refrain from provisioning the first device as a border router. Furthermore, in some implementations, at block 460, the commissioning device may determine whether to provision the first device as a joiner router (in addition to a border router). The device role of “joiner” (or endpoint joiner) cannot be combined with a role type of joiner router or border router. However, it is possible, in some implementations, for a first device to act as both a border router and a joiner router. For example, if the first device has both PAN and WLAN interfaces and is line-powered, then the first device may be provisioned as a border router and a joiner router.

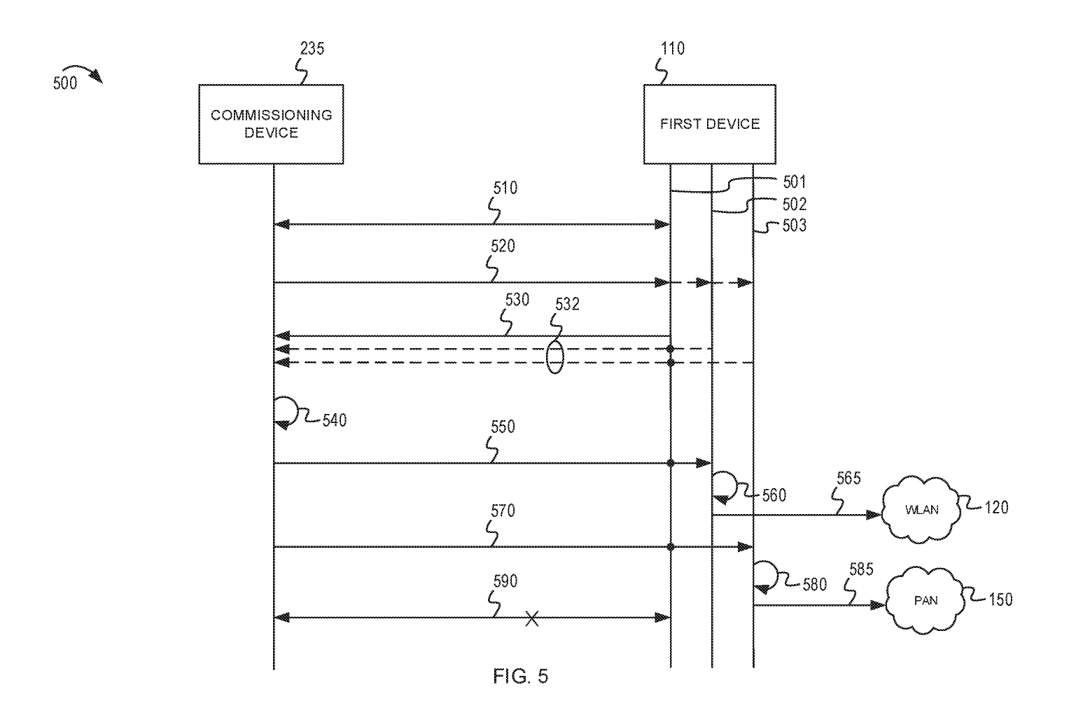

FIG. 5 shows an example message flow diagram of provisioning a first device for use in a WLAN and a PAN. The example message flow diagram 500 shows messages between a commissioning device 235 and a first device 110. In this example, the first device 110 has an out-of-band interface 501 (such as Bluetooth or NFC), a WLAN interface 502, and a PAN interface 503. The commissioning device 235 is capable of communicating with the out-of-band interface 501.

At arrow 510, the commissioning device 235 and the first device 110 may establish a provisioning communication link via the out-of-band interface 501. For example, the commissioning device 235 and the first device 110 may establish the provisioning communication link using a BLE peer-to-peer session. At message 520, the commissioning device 235 may request information from the first device 110. For example, the message 520 may be a query about the available interfaces (the WLAN interface 502 and the PAN interface 503), device settings, hardware data, or power supply type of the first device 110. At message 530, the first device 110 may respond to message 520 with the requested information. At messages 532, the first device 110 also may send information about the WLAN interface 502 and the PAN interface 503 using messages 532 over the provisioning communication link via the out-of-band interface 501. At process 540, the commissioning device 235 may use the gathered information to determine the device type and configuration settings to send to the first device 110.

At message 550, the commissioning device 235 may send a first network configuration for the WLAN interface 502 via the provisioning communication link. At process 560, the first device 110 may use the first network configuration to configure the WLAN interface 502 for use with the WLAN 120. Shown at arrow 565, the first device 110 may communicate with the WLAN 120 using the first network configuration at the WLAN interface 502.

Before terminating the provisioning communication link that was used to configure the WLAN interface 502, the commissioning device 235 can use the same provisioning communication link to configure the PAN interface 503. At message 570, the commissioning device 235 may send a second network configuration for the PAN interface 503 via the provisioning communication link. If the first device 110 is the first device in the PAN (also referred to as an initial leader), the second network configuration may include a commissioning credential. Otherwise, the second network configuration may include a joining passphrase that the first device 110 can use to establish a peer relationship with a second device of the PAN. In some implementations, the second network configuration also may include a list of other devices in the PAN which can accept the joining passphrase to join the first device 110 to the PAN. At process 580, the first device 110 may use the second network configuration to configure the PAN interface 503 for use with the PAN 150. Shown at arrow 585, the first device 110 may communicate with the PAN 150 using the second network configuration at the PAN interface 503. In some implementations, the second network configuration also may include a device type for the first device 110 to act as a border router (since the first device 110 has both the WLAN interface 502 and the PAN interface 503).

Shown at 590, the commissioning device 235 (or the first device 110) may terminate the provisioning communication link to the out-of-band interface 501 after both the WLAN interface 502 and the PAN interface 503 have been provisioned. In some implementations, before the provisioning communication link is terminated the first device 110 may send a confirmation via the provisioning communication link to the commissioning device 235. For example, the commissioning device 235 may receive a confirmation (not shown) that the WLAN and PAN were successfully provisioned and the commissioning device 235 may display (or otherwise present an audible or visual signal) an indication of such to a user of the commissioning device 235 via a display.

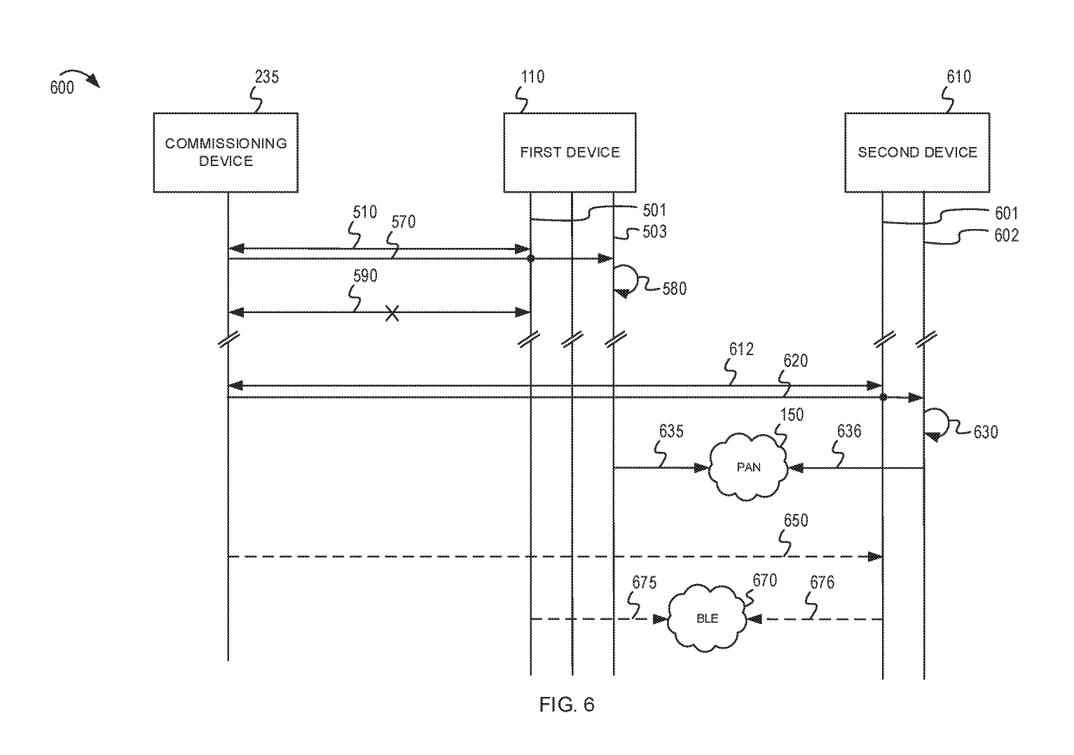

FIG. 6 shows an example message flow diagram of provisioning a second device for use in the PAN. The example message flow diagram 600 shows the commissioning device 235, the first device 110, and a second device 610 that needs to be added to the PAN. The messages and processes shown at 510, 570, 580, and 590 are similar to the corresponding messages and processes described in FIG. 5. As shown in FIG. 6, the first device 110 may have been provisioned as a border router since it has both a WLAN interface and a PAN interface 503. However, in addition to the role of border router, the first device 110 also may be provisioned as a joiner router. Thus, at message 570, the commissioning device 235 may have sent a commissioning credential to the first device 110 that can be used by the first device 110 to join a second device to the PAN (such as the second device 610).

Subsequently, to provisioning the first device 110, the commissioning device 235 may be used to provision a second device (the second device 610). At arrow 612, the commissioning device 235 and the second device 610 may establish a provisioning communication link via the out-of-band interface 601. For example, the commissioning device 235 and the second device 610 may establish a BLE session. The commissioning device 235 may query the second device 610 and determine a device type for the second device 610 using similar messages (not shown in FIG. 6) as messages 520, 530, 540 described in FIG. 5. At message 620, the commissioning device 235 can use the provisioning communication link to configure the PAN interface 602. For example, the commissioning device 235 may send a network credential (such as a joining passphrase) to the second device 610. At 630, the 610 can use the joining passphrase to join the PAN 150. For example, the joining passphrase can authenticate the PAN interface 602 to a joiner router or border router of the PAN 150. Thereafter, the first device 110 and the second device 610 can communicate (shown at arrows 635, 636) via the PAN 150.

FIG. 6 shows another example implementation which can be used while provisioning devices. The commissioning device 235 may optionally connect the second device 610 to the out-of-band interface 501 of the first device 110. For example, the commissioning device 235 may assist the establishment of a secure peer-to-peer session (via short-range radio frequency communication, such as Bluetooth or NFC) between the first device 110 and the second device 610. The commissioning device 235 may have determined pairing information (such as peer-to-peer pairing information assocaited with the provisioning communication link at 510) for the first device 110. At message 650, the commissioning device 235 may provide the pairing information to the second device 610. Providing the pairing information to the second device 610 may enable the second device 610 to establish a peer-to-peer session between the second device 610 and the first device 110. Shown at 675, 676, the first device 110 and the second device 610 may communicate using a provisioning communication link 670 (such as via a Bluetooth or NFC communication). The peer-to-peer session 670 may use the out-of-band interface 501 and the out-of-band interface 601 as an alternative to the PAN 150. For example, the peer-to-peer session 670 may be used for the first device 110 and the second device 610 to complete further out-of-band network configuration related to the PAN 150.

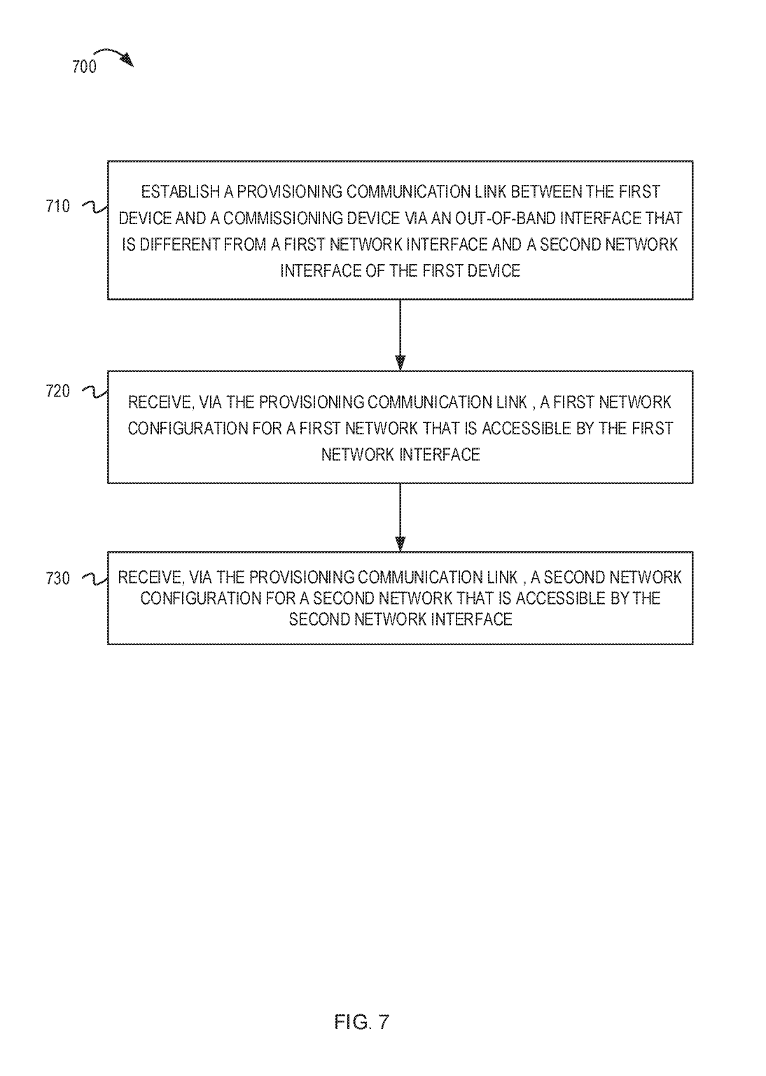

FIG. 7 shows an example flowchart for a first device being provisioning by a commissioning device. The example flowchart 700 begins at block 710. At block 710, the first device may establish a provisioning communication link between the first device and a commissioning device via an out-of-band interface that is different from a first network interface and a second network interface of the first device. For example, the out-of-band interface may be a short-range radio frequency communication interface (such as Bluetooth or NFC). At block 720, the first device may receive, via the provisioning communication link, a first network configuration for a first network that is accessible by the first network interface. For example, the first network configuration may configure the first network interface for use with a WLAN. At block 730, the first device may receive, via the provisioning communication link, a second network configuration for a second network that is accessible by the second network interface. For example, the second network configuration may be a joining passphrase for the second network interface to join a PAN. The second network configuration may include a commissioning credential if the first device is an initial leader of the PAN or if the first device will be a joining router of the PAN.

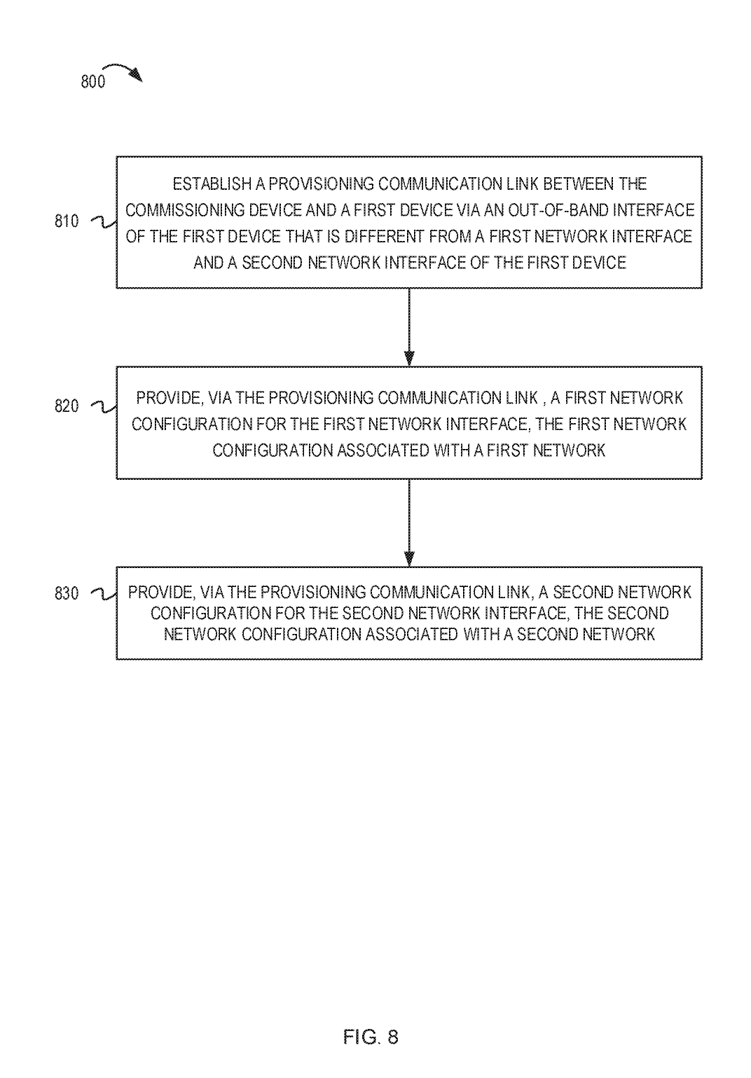

FIG. 8 shows an example flowchart for a commissioning device provisioning a first device. The example flowchart 800 begins at block 810. At block 810, the commissioning device may establish a provisioning communication link between the commissioning device and a first device via an out-of-band interface of the first device that is different from a first network interface and a second network interface of the first device. For example, the out-of-band interface may be a short-range radio frequency communication interface (such as Bluetooth or NFC). At block 820, the commissioning device may provide, via the provisioning communication link, a first network configuration for the first network interface, the first network configuration associated with a first network. For example, the first network configuration may configure the first network interface for use with a WLAN. At block 830, the commissioning device may provide, via the provisioning communication link, a second network configuration for the second network interface, the second network configuration associated with a second network. For example, the second network configuration may be a joining passphrase, a commissioning credential, or both for the second network interface to use with a PAN.

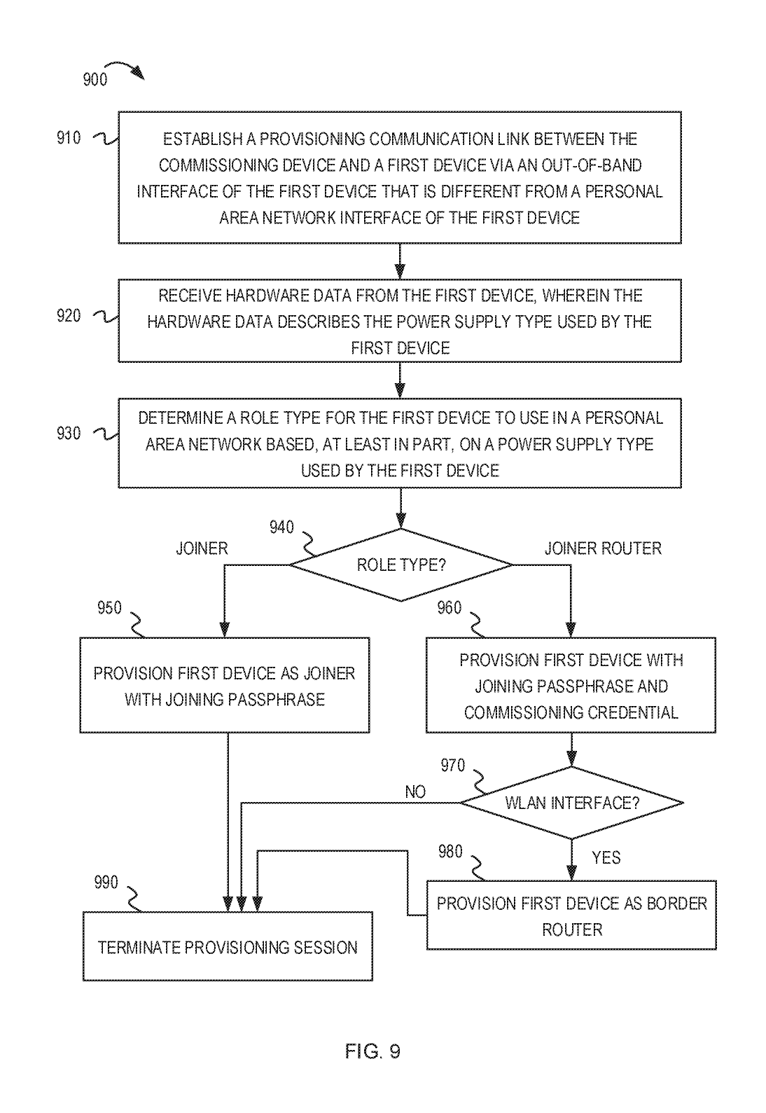

FIG. 9 shows an example flowchart for a commissioning device provisioning a first device based on a role type. The example flowchart 900 begins at block 910. At block 910, the commissioning device may establish a provisioning communication link between the commissioning device and a first device via an out-of-band interface of the first device that is different from a personal area network interface of the first device. At block 920, the commissioning device may receive hardware data from the first device. For example, the hardware data may describe the power supply type used by the first device. At block 930, the commissioning device may determine a role type for the first device to use in a personal area network based, at least in part, on a power supply type used by the first device. For example, the commissioning device may determine the role type using a similar process as described in FIG. 4.

At decision 940, the flow may branch based on the determined role type. If the role type is “joiner” (or endpoint joiner), the flow continues to block 950. At block 950, the commissioning device may provision the first devices as a joiner with a joining passphrase. From block 950, the flow continues to block 990.

At decision 940, if the role type is a joiner router (or border router that is also a joiner router), the flow continues to block 960. At block 960, the commissioning device may provision the first device with a joining passphrase (for itself to join the PAN) and a commissioning credential (for the first device to commission other new PAN devices).

At decision 970, the commissioning device may determine if the first device has a WLAN interface (in addition to the PAN interface that was previously configured in block 960). If the first device does not have a WLAN interface, the flow continues to block 990. However, if the first device does have a WLAN interface, the flow continues to block 980. At block 980, the commissioning device may provision the first device as a border router. For example, the commissioning device may instruct the first device to bridge traffic between the PAN and the WLAN. From block 980, the flow continues to block 990.

At block 990, the commissioning device may terminate the provisioning communication link with the first device. Optionally, the commissioning device may display or otherwise present the results of the provisioning via a user interface of the commissioning device.

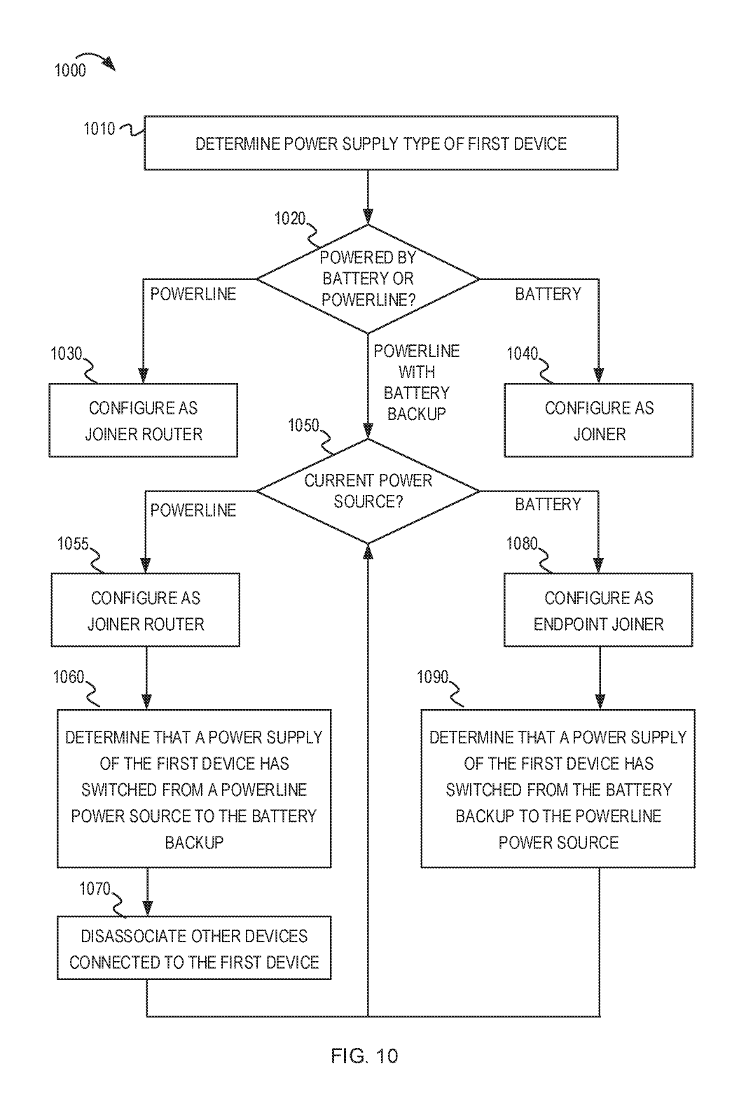

FIG. 10 shows an example flowchart for in which a first device may change a role type based on power source. The example flowchart 1000 may be used when the first device has a role type based on power source. For example, the role type may be that of a joiner, a joiner router, or a border router, and may change based on the current power source used by the first device. The flowchart 1000 begins at block 1010.

At block 1010, the first device may determine the power supply type of the first device. At decision 1020, the flowchart may branch based on whether the first device is battery-powered, powerline-powered, or powerline-powered with a battery backup. At decision 1020, if the first device is powerline-powered, the flow continues to block 1030. At block 1030, the first device may configure its PAN interface to operate as a joiner router in the PAN. At decision 1020, if the first device is battery-powered, the flow continues to block 1040. At block 1040, the first device may configure its PAN interface to operate as an endpoint joiner in the PAN.

At decision 1050, if the first device currently using powerline power, the flow continues to block 1055. At block 1055, the first device may initially configure its PAN interface to operate as a joiner router in the PAN. Thus, the first device may be initially configured to operate as a joiner router in the PAN because the first device is using powerline-provided powered. At block 1060, the first device may determine that a power supply of the first device has switched from a powerline power source to the battery backup. For example, if the first device fails to obtain sufficient power from the powerline power source, the first device may switch to the battery backup. As a result of changing to battery power, the first device may change a role type for the first device from the joiner router to the endpoint joiner. In preparation for changing the role type, at block 1070, the first device may disassociate other devices connected to the first device. The flow returns to decision 1050 to determine the current power source being used by the first device.

At decision 1050, if the first device currently using battery power, the flow continues to block 1080. At block 1080, the first device may configure its PAN interface to operate as an endpoint joiner in the PAN. The first device may subsequently change the role type when power source changes again. For example, at block 1090, the first device may determine that a power supply of the first device has switched from the powerline power source to the battery backup. For example, the first device may restores powerline power (away from battery backup). Following block 1090, the flow returns to decision 1050 to determine the current power source being used by the first device.

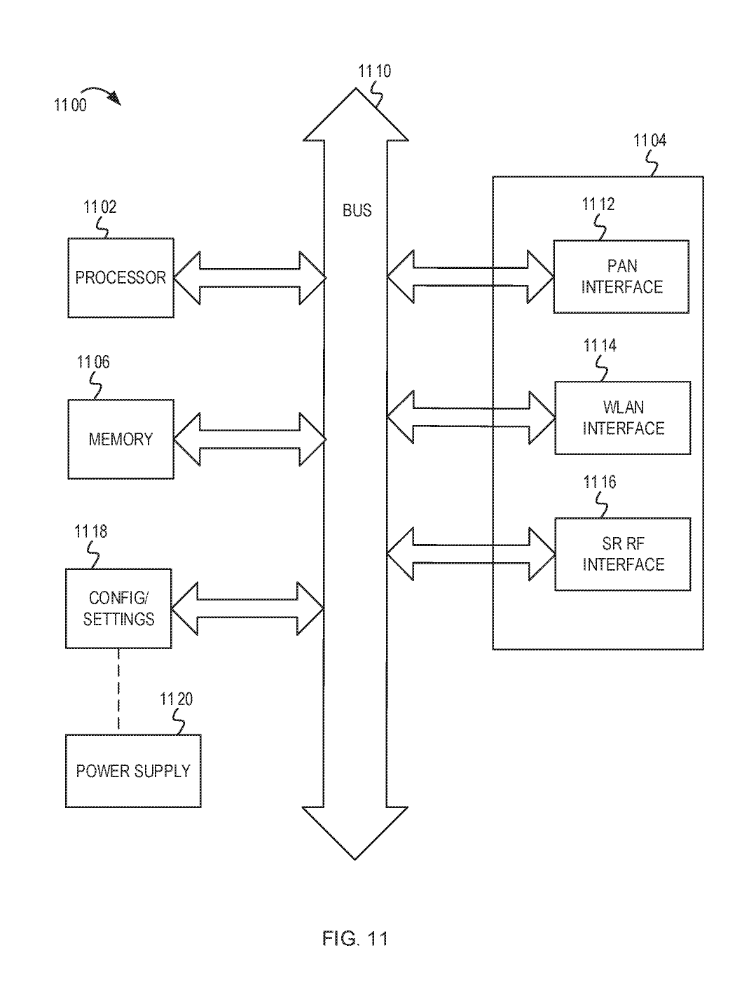

FIG. 11 shows a block diagram of an example electronic device for implementing aspects of this disclosure. In various implementations, the electronic device 1100 may be similar to the devices described in this document, such as the commissioning device 235, the first device 111, or the second device 610. For example, the electronic device 1100 may be an IoT device, an embedded device, a laptop computer, a tablet computer, a mobile phone, a gaming console, a smartwatch, virtual or augmented reality device, a drone, or another electronic system that is capable of operating in a PAN. The electronic device 1100 includes a processor 1102 (possibly including multiple processors, multiple cores, multiple nodes, or implementing multi-threading, etc.). The electronic device 1100 includes a memory 1106. The memory 1106 may be system memory or any one or more of the below-described possible realizations of a machine-readable medium or computer-readable medium. The memory 1106 includes functionality to support various implementations described above. The memory 1106 may include one or more functionalities that facilitate implementation of a device provisioning as described herein. For example, memory 1106 can implement one or more aspects of a first device for use in a PAN or a commissioning device for provisioning the first device. The memory 1106 can embody functionality to enable implementations described in FIGS. 1-9 above. The electronic device 1100 also may include a bus 1101 (such as PCI, ISA, PCI-Express, HyperTransport®, InfiniBand®, NuBus, AHB, AXI, etc.).

The electronic device 1100 may include one or more network interfaces 1104, which may include a PAN interface 1112 (such as a Thread network interface, a ZigBee® interface, a Wireless USB interface, etc.), a WLAN interface 1114 (such as an IEEE 802.11 WLAN interface, or the like), and a short-range radio frequency interface (such as a Bluetooth interface or an NFC interface). In some implementations, the electronic device 1100 also may have a wired network interface (such as a powerline communication interface, an Ethernet interface, etc.). Thus, electronic device 1100 may support multiple network interfaces 1104, each of which may be configured to couple the electronic device 1100 to a different communication network. The electronic device 1100 also may have storage for configuration or settings 1118. For example, the configuration or settings 1118 may indicate a power supply type for a power supply 1120 of the electronic device 1100.

Any one of these functionalities may be partially (or entirely) implemented in hardware, such as on the processor 1102. For example, the functionality may be implemented with an application specific integrated circuit, in logic implemented in the processor 1102, in a co-processor on a peripheral device or card, etc. Further, realizations may include fewer or additional components not illustrated in FIG. 11 (such as video cards, audio cards, additional network interfaces, peripheral devices, etc.). The processor 1102, and the memory 1106, may be coupled to the bus 1101. Although illustrated as being coupled to the bus 1101, the memory 1106 may be directly coupled to the processor 1102.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends on the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include cache memory, RAM (including SRAM, DRAM, zero capacitor RAM, Twin Transistor RAM, eDRAM, EDO RAM, DDR RAM, EEPROM, NRAM, RRAM, SONOS, PRAM, or the like), ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations of the above also can be included within the scope of computer-readable media. Additionally, the operations of a method or algorithm may reside as one or any combination or set of codes and instructions on a machine-readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method performed by a first device for use in at least one communication network, the method comprising:
establishing a provisioning communication link between the first device and a commissioning device via an out-of-band interface that is different from a first network interface and a second network interface of the first device;
receiving, via the provisioning communication link, a first network configuration for a first network that is accessible by the first network interface; and
receiving, via the provisioning communication link, a second network configuration for a second network that is accessible by the second network interface.

2. The method of claim 1, further comprising:
establishing communication with the first network via the first network interface using the first network configuration; and
establishing communication with the second network via the second network interface using the second network configuration.

3. The method of claim 2, wherein the first network is a wireless local area network and the second network is a personal area network.

4. The method of claim 1, wherein the out-of-band interface is a short-range radio frequency communication interface, and wherein the provisioning communication link is a secure peer-to-peer session using short-range radio frequency communication.

5. The method of claim 1, wherein receiving the second network configuration includes at least one of receiving a commissioning credential or a joining passphrase for a personal area network.

6. The method of claim 1, wherein receiving the second network configuration includes receiving a role type for the first device to use in a personal area network, and wherein the role type is based, at least in part, on a power supply type used by the first device.

7. The method of claim 6, further comprising, before receiving the second network configuration:
providing hardware data to the commissioning device, wherein the hardware data describes the power supply type used by the first device.

8. The method of claim 6,
wherein the role type for the first device indicates the first device is a joiner router in the personal area network when the power supply type of the first device is powerline-powered; and
wherein the role type for the first device indicates the first device is an endpoint joiner when the power supply type of the first device is battery-powered.

9. The method of claim 8, wherein the first device is powerline-powered and the first device has a battery backup, the method further comprising:
determining that a power supply of the first device has switched from a powerline power source to the battery backup; and
changing a role type for the first device from the joiner router to the endpoint joiner in response to determining that the power supply of the first device has switched from the powerline power source to the battery backup.

10. The method of claim 9, further comprising:
in response to changing the role type to the endpoint joiner:
disassociating other devices connected to the first device; and
re-establishing communication with the second network via the second network interface using the role type of the endpoint joiner.

11. The method of claim 1, further comprising:
determining pairing information for the out-of-band interface, wherein the pairing information is used between the first device and a second device that is configured with the pairing information by the commissioning device;
receiving a pairing request from the second device;
determining that the pairing request matches the pairing information; and
establishing a peer-to-peer session with the second device in response to determining that the pairing request matches the pairing information.

12. A first device for use in at least one communication network, comprising:
a processor;
a first network interface;
a second network interface;
an out-of-band interface that is different from the first network interface; and
memory coupled with the processor and having instructions stored therein which, when executed by the processor cause the first device to:
establish a provisioning communication link between the first device and a commissioning device via the out-of-band interface;
receive, via the provisioning communication link, a first network configuration for a first network that is accessible by the first network interface; and
receive, via the provisioning communication link, a second network configuration for a second network that is accessible by the second network interface.

13. The first device of claim 12, wherein the instructions, when executed by the processor, cause the first device to:
establish communication with the first network via the first network interface using the first network configuration; and
establish communication with the second network via the second network interface using the second network configuration.

14. The first device of claim 12, wherein receiving the second network configuration includes at least one of receiving a commissioning credential or a joining passphrase for a personal area network.

15. The first device of claim 12, wherein the second network configuration includes a role type for the first device to use in a personal area network, and wherein the role type is based, at least in part, on a power supply type used by the first device.

16. The first device of claim 15, wherein the instructions, when executed by the processor, cause the first device to:
provide hardware data to the commissioning device, wherein the hardware data describes the power supply type used by the first device.

17. The first device of claim 12, wherein the instructions, when executed by the processor, cause the first device to:
determine pairing information for the out-of-band interface, wherein the pairing information is used between the first device and a second device that is configured with the pairing information by the commissioning device;
receive a pairing request from the second device;
determine that the pairing request matches the pairing information; and
establish a peer-to-peer session with the second device in response to a determination that the pairing request matches the pairing information.

18. A machine-readable medium having instructions stored therein which, when executed by a processor of a first device, cause the first device to:
establish a provisioning communication link between the first device and a commissioning device via an out-of-band interface that is different from a first network interface and a second network interface of the first device;
receive, via the provisioning communication link, a first network configuration for a first network that is accessible by the first network interface; and
receive, via the provisioning communication link, a second network configuration for a second network that is accessible by the second network interface.

19. The machine-readable medium of claim 18, wherein the instructions, when executed by the processor, cause the first device to:
establish communication with the first network via the first network interface using the first network configuration; and
establish communication with the second network via the second network interface using the second network configuration.

20. The machine-readable medium of claim 18, wherein receiving the second network configuration includes at least one of receiving a commissioning credential or a joining passphrase for a personal area network.

21. The machine-readable medium of claim 18, wherein the second network configuration includes a role type for the first device to use in a personal area network, and wherein the role type is based, at least in part, on a power supply type used by the first device.

22. The machine-readable medium of claim 21, wherein the instructions, when executed by the processor, cause the first device to:
provide hardware data to the commissioning device, wherein the hardware data describes the power supply type used by the first device.

23. The machine-readable medium of claim 18, wherein the instructions, when executed by the processor, cause the first device to:
determine pairing information for the out-of-band interface, wherein the pairing information is used between the first device and a second device that is configured with the pairing information by the commissioning device;
receive a pairing request from the second device;
determine that the pairing request matches the pairing information; and
establish a peer-to-peer session with the second device in response to a determination that the pairing request matches the pairing information.

24. A method performed by a commissioning device, the method comprising:
establishing a provisioning communication link between the commissioning device and a first device via an out-of-band interface of the first device that is different from a first network interface and a second network interface of the first device;
providing, via the provisioning communication link, a first network configuration for the first network interface, the first network configuration associated with a first network; and
providing, via the provisioning communication link, a second network configuration for the second network interface, the second network configuration associated with a second network.

25. The method of claim 24, wherein providing the second network configuration includes at least one of providing a commissioning credential or a joining passphrase for a personal area network.

26. The method of claim 24, further comprising:
determining a role type for the first device to use in a personal area network based, at least in part, on a power supply type used by the first device, and
wherein the second network configuration is based, at least in part, on the role type.

27. The method of claim 26,
wherein the role type for the first device indicates the first device is a joiner router in the personal area network when the power supply type of the first device is determined to be powerline-powered; and
wherein the role type for the first device indicates the first device is an endpoint joiner when the power supply type of the first device is determined to be battery-powered.

28. The method of claim 27, wherein providing the second network configuration includes:
providing a commissioning credential when the role type for the first device indicates the first device is a joiner router; and
providing a joining passphrase when the role type for the first device indicates the first device is the endpoint joiner.

29. The method of claim 24, further comprising:
determining pairing information for the out-of-band interface; and
providing the pairing information to a second device, such that thea second device can establish a peer-to-peer session between the second device and the first device.

30. The method of claim 24, further comprising:
providing, via the provisioning communication link, a list of addresses of one or more existing devices in a personal area network that can accept a connection request from the first device.
